(19) United States
(12) Patent Application Publication
(10) Pub. No.: US 2015/0215099 A1
(43) Pub. Date: Jul. 30, 2015

(54) System and Method for Channel Quality Feedback

(71) Applicant: Futurewei Technologies, Inc., Plano, TX (US)

(72) Inventors: Xiaolei Tie, Shanghai (CN); Peng Zhang, Shanghai (CN); Carmela Cozzo, San Diego, CA (US); Zongjie Wang, Shanghai (CN); Meng Hua, Shanghai (CN)

(21) Appl. No.: 14/610,942

(22) Filed: Jan. 30, 2015

Related U.S. Application Data
(60) Provisional application No. 61/933,538, filed on Jan. 30, 2014.

(51) Int. Cl. H04L 5/00

(52) U.S. Cl. CPC H04L 5/0057

(57) ABSTRACT

In one embodiment, a method includes receiving a first indicator of channel quality between a user equipment (UE) and a first network node and receiving a second indicator of channel quality between the UE and a second network node. The method also includes processing the first indicator of channel quality and processing the second indicator of channel quality.

This application claims the benefit of U.S. Provisional Application Ser. No. 61/933,538 filed on Jan. 30, 2014, and entitled “System and Method for CQI Feedback for Coordinated Scheduling,” which application is hereby incorporated herein by reference.

### TECHNICAL FIELD

The present invention relates to a system and method for wireless communications, and, in particular, to a system and method for channel quality indicator feedback.

### BACKGROUND

Heterogeneous networks (Hetnets) increase network capacity and coverage in wireless networks. Heterogeneous networks have a mix of high power nodes (macro nodes) and low power nodes (LPNs). User equipments (UEs) are offloaded from the macro node to LPNs to utilize higher data rates. The system capacity and coverage gains may come from the increased scheduling opportunities provided by the LPN. Thus, offloading more UEs to be served by LPNs instead of macro nodes is useful in Hetnet deployments. The increased offloading may be obtained by using the Cell Individual Offset (CIO) parameter, so the UE chooses an LPN more often as a serving cell. With an increased CIO value, the LPN coverage is effectively expanded, and more UEs with low geometry are served by LPNs. The use of interference cancellation (IC) at the UE facilitates the performance of low geometry UEs. A UE with IC capacity (IC UE) cancels the interference generated by the downlink transmission of the macro nodes. The efficiency of IC may be related to the strength and format of the interfering signal.

### SUMMARY

An embodiment method includes receiving a first indicator of channel quality between a user equipment (UE) and a first network node and receiving a second indicator of channel quality between the UE and a second network node. The method also includes processing the first indicator of channel quality and processing the second indicator of channel quality.

An embodiment method includes transmitting, by a radio network controller (RNC) to a serving node, a transmission pattern and transmitting, by the RNC to a non-serving node, the transmission pattern. The method also includes receiving, by the RNC, a measurement report indicating a quality of a first channel between a user equipment (UE) and the serving node and a quality of a second channel between the UE and the non-serving node and determining a transmission condition in accordance with the measurement report.

An embodiment method includes determining a first indicator of channel quality between a user equipment (UE) and a serving node and determining a second indicator of channel quality between the UE and a first non-serving node. The method also includes transmitting the first indicator of channel quality and transmitting the second indicator of channel quality.

An embodiment method includes receiving, by a radio network controller (RNC) from a user equipment (UE), a first indicator of channel quality and receiving, by the RNC from the UE, a second indicator of channel quality. The method also includes processing the first indicator of channel quality and processing the second indicator of channel quality.

An embodiment first node includes a processor and a non-transitory computer readable storage medium storing programming for execution by the processor. The programming including instructions to receive a first indicator of channel quality between a first user equipment (UE), and the first network node and receive a second indicator of channel quality between the UE and a second network node. The programming also includes instructions to process the first indicator of channel quality and process the second indicator of channel quality.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example of channel quality indicator (CQI) mismatch;

FIG. 2 illustrates an embodiment schedule compensating for CQI mismatch;

FIG. 3 illustrates an embodiment system for CQI feedback;

FIG. 4 illustrates another embodiment system for CQI feedback;

FIG. 5 illustrates an additional embodiment system for CQI feedback;

FIG. 6 illustrates an embodiment message diagram for CQI feedback;

FIG. 7 illustrates another embodiment message diagram for CQI feedback;

FIG. 8 illustrates an additional embodiment message diagram for CQI feedback;

FIG. 9 illustrates a flowchart for an embodiment method of CQI feedback performed by a user equipment (UE);

FIG. 10 illustrates a flowchart for an embodiment method of CQI feedback performed by a serving node;

FIG. 11 illustrates a flowchart for an embodiment method of CQI feedback performed by an interfering node;

FIG. 12 illustrates a flowchart for an embodiment method of CQI feedback performed by a radio network controller (RNC); and

FIG. 13 illustrates a block diagram of an embodiment computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

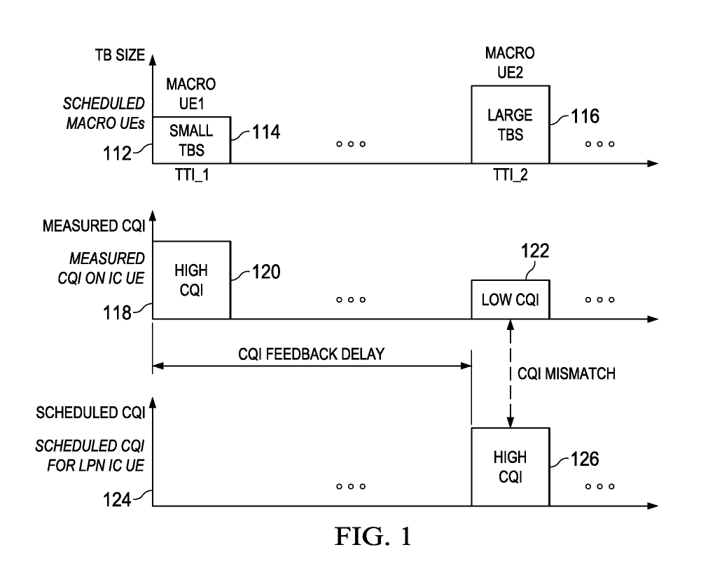

The inaccuracy of the channel quality indicator (CQI) estimate may degrade the performance of interference cancellation (IC) user equipments (UEs) (UE ICs). The cancellation efficiency relates to the transport format of the interference and the instantaneous channel conditions of the interference. When the serving cell schedules the IC UE, the cancellation efficiency may vary. The scheduled transport format of the interference is not predictable for the IC UE and its serving cell. The channel condition also varies. FIG. 1 illustrates an example of CQI mismatch. Graph 112 shows scheduled macro UEs for macro UE1 with transport block size (TBS) 114, a small TBS transmitted at transmission time interval (TTI) TTI_1 and macro UE2 with TBS 116, a large TBS transmitted at TTI_2. Graph 118 shows the measured CQI on an IC UE, CQI 120 of a high CQI associated with TBS 114 in TTI_1 and CQI 122, a low CQI associated with TBS 116 in TTI_2. There is a CQI feedback delay due to the transmission from the UE to the network and scattering delay on the network node. Graph 124 shows the scheduled CQI for LPN IC UE, CQI 126, which is a high CQI because it refers to the transmission in TTI_1. There is a CQI mismatch between CQI 122 and CQI 126.

Scheduling coordination may be used to resolve the CQI mismatch. Scheduling at the macro node and the low power node (LPN) is coordinated, and, in some subframes, called restricted resource subframes (RRSs), the macro cell scheduler applies a restriction on scheduling the downlink (DL) transmissions from the macro node. A network node may be any component capable of providing wireless access with a UE, such as a base station, a NodeB, an enhanced nodeB (eNB), an access point, a macro cell, a pico cell, a femtocell, an LPN, or another wirelessly enabled device. A UE may be any component capable of establishing a wireless connection with a network node, such as cell phones, smart phones, tablets, sensors, etc. The restricted resources may include the transport block (TB) size, CQI value, modulation type, number of codes, and other factors. Because of more stable or predictable interference during the RRS, the serving cell may schedule more accurate TB sizes for the IC UE, mitigating the CQI mismatch.

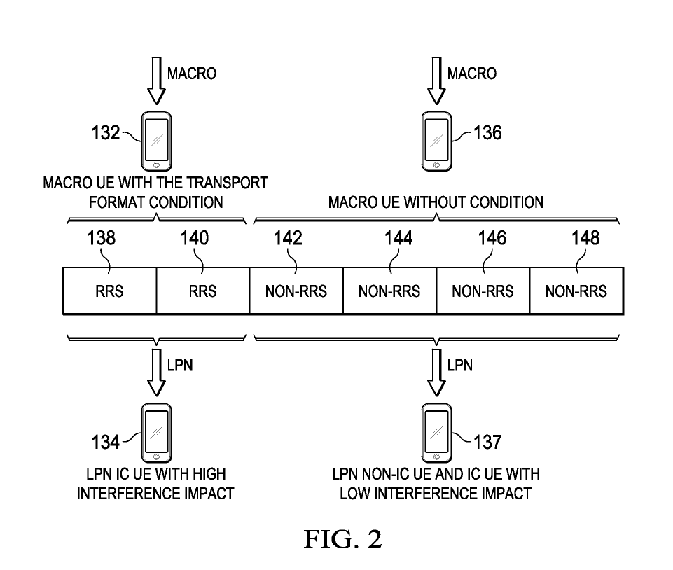

FIG. 2 illustrates an RRS pattern based coordinated scheduling scheme. On the macro cell, in some specific TTIs, such as TTI 138 and TTI 140, which are restricted resources subframes, only some pre-defined transport formats are transmitted. In other TTIs, such as TTI 142, TTI 144, TTI 146, and TTI 148, which are non-RRS frames, there is no condition on the transmitted transport format by the macro cell. On the LPN side, the LPN schedules the LPN IC UE on the restricted resource subframes with higher priority. Depending on the network load, different RRS patterns care used.

Coordinated scheduling aims at scheduling the UEs served by an LPN in a stable interference environment. In co-channel scenarios, it is problematic to dynamically exchange the scheduling status between the macro nodes and the LPNs. A pattern-based coordinated scheduling supports coordinated scheduling between the macro node and LPNs, in which an expected RRS pattern is pre-configured on the macro node and LPNs. For scheduling, the macro node follows the pre-configured pattern to produce the expected RRS pattern. The LPNs schedule the cell edge IC UEs only in specific subframes with good interference structures, based on the pre-configured pattern. The pattern based coordinated scheduling may exploit the IC gain of the IC UEs.

During an RRS, there may be a condition for choosing the resources (e.g., transport format) to be allocated for downlink transmission at the macro node. When this is set statically by high layer signaling, performance may degrade because the IC efficiency varies even between different RRSs. The channel condition changes based on fading and the IC UE position, impacting the IC efficiency. The channel condition may be unknown by the interfering node (macro node) in a coordinated scheduling scheme. It is desirable that the condition for choosing the transport format on an RRS be flexible and dynamically updated based on the channel conditions between the interfering non-serving node (macro node) and the IC UEs at the edge of the LPN coverage. Knowledge of the channel conditions between the interfering cell and the IC UEs may be used.

An embodiment provides feedback signaling from an IC UE to a non-serving node about the channel conditions in the non-serving node. This feedback may be sent directly by the IC UE to the non-serving node or may be relayed from the serving node to the non-serving node through a radio network controller (RNC). An embodiment method informs the network about the channel conditions between the interfering (non-serving) cell and the edge IC UEs. In this scenario, which refers to Hetnet deployment, the non-serving node is the macro node and the serving node is the LPN. Embodiments also apply to homogeneous networks where all network nodes transmit at the same power, and one network node is the serving node and one or more network node(s) are the non-serving nodes for the IC UE. The non-serving node may be either included in the active set or not included in the active set.

An embodiment feeds back CQI of a non-serving cell to the serving cell or to both the serving and non-serving cells. Knowledge of IC capabilities may be used in scheduling/offloading UEs. Embodiments may be implemented in universal mobile telecommunications service (UMTS) heterogeneous networks and devices, such as network nodes, UEs, etc.

In an embodiment IC UE, two CQI values are evaluated and reported: a serving cell CQI, which is measured based on a link from the serving cell, CQI_{serving cell, IC UE}, and from an interfering cell, CQI_{interfering cell, IC UE}. The serving cell of IC UEs, e.g. the LPN in Hetnet, schedules the IC UE on the LPN edge on RRSs. Also, the interfering node, e.g. the macro cell in Hetnet, using the reported interfering CQI values of all the IC UEs, evaluates the channel condition between the interfering node and the IC UEs. Based on these channel conditions, the interfering node, for example a macro node in Hetnet, selects a condition on the interfering transport structure, so the IC efficiency is stable on RRSs for IC UEs in the serving sell, such as a pico cell in Hetnet.

In one embodiment, the RNC configures a long-term semi-static condition on transport format on the RRSs to the macro cell using Iub signaling, where Iub is the logical interface between an RNC and a network node. The condition may be determined by the RNC based on measurements reported by the IC UE.

In another embodiment, the condition for the transport format relates to the signal to interference plus noise ratio (SINR) of the channel between the interfering cell (macro node in Hetnet) and the IC UE (LPN IC UE in Hetnet). Thus, the condition for the transport format is determined based on the channel conditions between the interfering cell and the IC UE. The CQI values for interfering cells are reported to the network. In addition to the CQI values from the serving cell, CQI_{serving cell, IC UE}, the IC UE evaluates the CQI value from the interfering cell, CQI_{interfering cell, IC UE}, and reports it to the network. These two CQI values are reported by a high speed dedicated physical control channel (HS-DPCCH) to both the interfering cell (macro node) and the serving node (LPN). The encoding of HS-DPCCH may be single frequency dual cell (SF-DC) mode coded or multiple-input multiple-output (MIMO) mode coded. Alternatively, these two CQI values are reported by HS-DPCCH to only the serving cell. Then, the serving cell forwards the related information of the interfering CQI to the interfering cell.

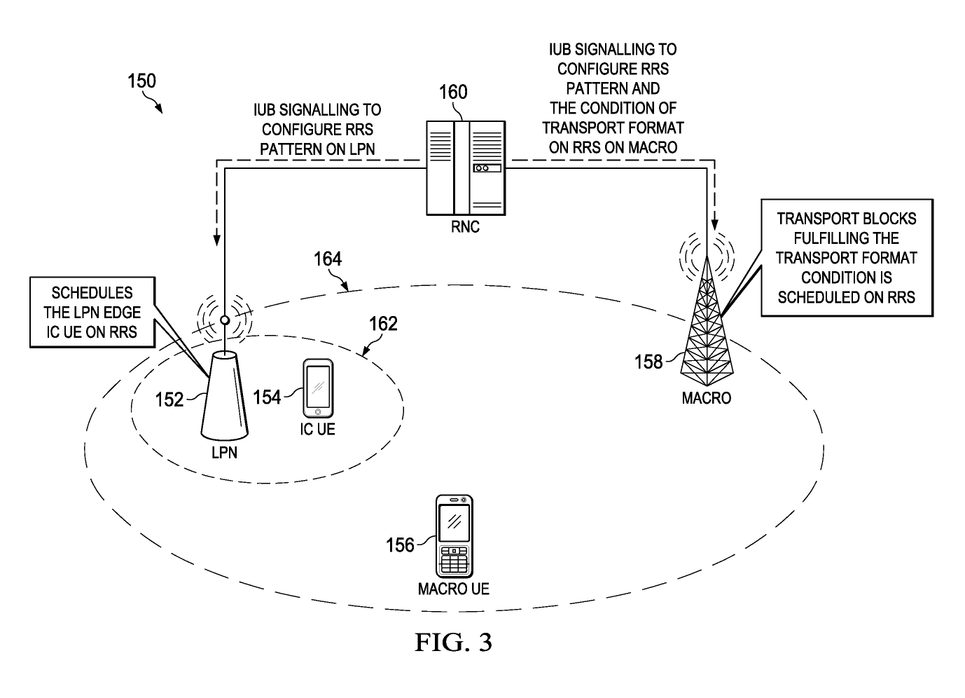

FIG. 3 illustrates system 150 for CQI feedback managed by an RNC. A condition for macro nodes during the RRS is determined by the RNC, so interference may be cancelled with a particular IC efficiency. On the RRSs, the macro node only schedules downlink frames meeting the RRS condition, on LPN edge IC UEs having a particular IC efficiency. Macro node 158 with coverage area 164 communicates with macro UE 156. In coverage area 164 is LPN 152, which has coverage area 162. LPN communicates with IC UE 154. On the RRSs, the LPN may schedule IC UEs which are located at the cell edge of LPN 152. RNC 160 configures a long term semi-static RRS pattern on LPN 152 and macro node 158 using Iub signaling. This configures the RRS pattern in the macro node and LPN.

IC UE 154 performs a measurement on the channel condition on the channel between IC UE 154 and LPN 152 and on the channel between IC UE 154 and macro node 158. The measurement may be the measured received signal code power (RSCP) or common pilot channel (CPICH) energy per chip (Ec) on the spectral density (No). The measurements are reported to RNC 160, for example relayed by LPN 152 or macro node 158.

The RRS condition is determined by RNC 160 based on the measurements reported by IC UE 154 and relayed by LPN 152 or macro node 158. The reported measurements may include the RSPC or CPICH Ec/No for both the serving cell and the interfering cell. RNC 160 may determine the CPICH difference for IC UE 154 between the interfering cell and the serving cell. A larger CPICH difference indicates that the signal from LPN 152 to IC UE 154 is relatively weak and the signal from macro node 158 to IC UE 154 is relatively strong. When the IC UE is closer to macro node 158, more IC gain may be achieved. Also, RNC 160 may determine the average macro CQI and LPN CQI for IC UE 154 based on the CPICH Ec/No from macro node 158 and LPN 152. In another example, the reported information to the RNC may include information about the location and the IC gain of IC UE 154. The location information may include a location category, such as near, middle, or far, or a more detailed description of the location. The IC gain may be based on coarse categories, such as large, medium, or small IC gain, or a more detailed description. Signaling from RNC 160 to macro node 158 may relay the location and/or IC gain information to macro node 158. When macro node 158 knows the location of the UE, it may use this information to enhance downlink scheduling.

In one example with a post-decoding IC UE, the RRS condition is a threshold for the scheduled transport block size in the interfering cell. On RRSs, only transport block sizes smaller than the threshold are scheduled in the interfering cell (macro cell). In another example with a pre-decoding IC UE, the RRS condition is a modulation type on the RRS, and/or a threshold of the number of used codes in the RRS. Only the specified modulation is used in the macro cell on RRS.

RNC 160 informs macro node 158 of the RRS condition. This condition may be transmitted using Iub signaling. Macro node 158 then schedules transport blocks fulfilling the conditions on the RRS based on the indicated transport format condition on RRS.

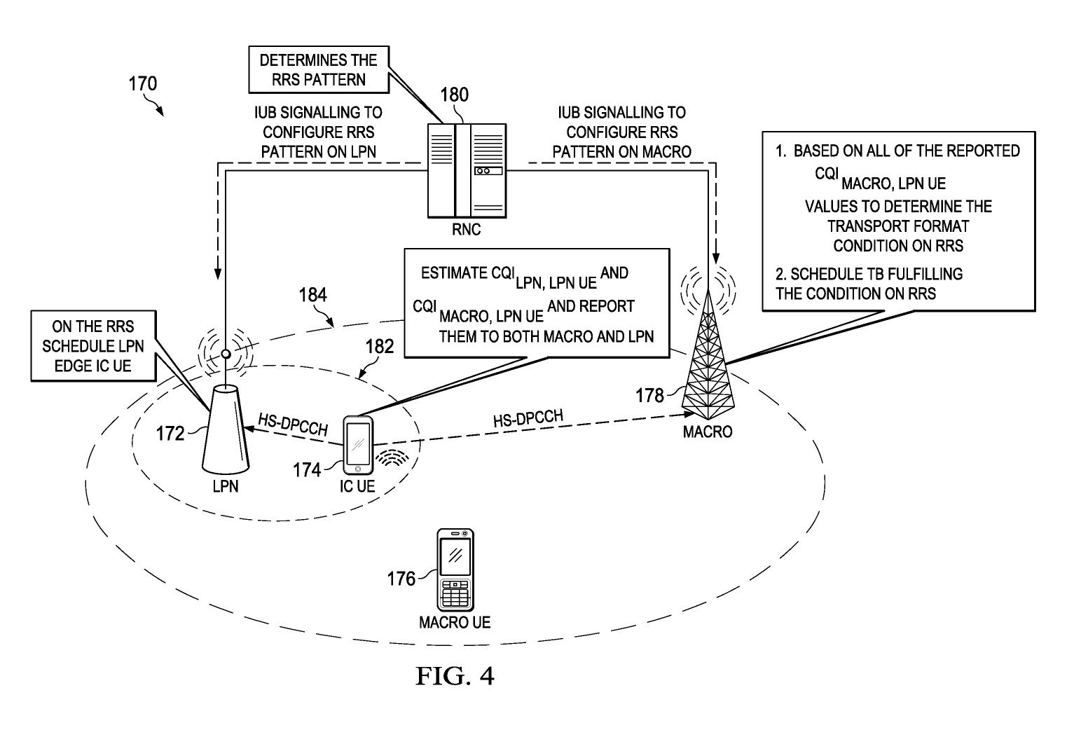

FIG. 4 illustrates system 170 for CQI feedback using dynamic RRS conditions determined by a macro node. The RRS condition is determined so interference may be cancelled with a particular IC efficiency. Macro node 178 has a coverage area 184, and communicates with macro UE 176. LPN 172 in coverage area 184 has a coverage area 182. IC UE 174 communicates with both LPN 172 and macro node 178, where LPN 172 is the serving node and macro node 178 is the interfering node. RNC 180 communicates with both LPN 172 and macro node 178 using Iub signaling.

RNC 180 transmits the information of the RRS pattern to macro node 178 and LPN 172. The RRS condition relates to the SINR of the channel between the interfering cell (macro node 178) and the IC UE (IC UE 174). The RRS condition is based on the channel conditions between the interfering cell and the related IC UE. CQI values for the serving cell, CQI_{serving cell, IC uE}, and the CQI values from the interfering cell, CQI_{interfering cell, IC UE} are reported to both macro node 178 and LPN 172 using high speed dedicated physical control channel (HS-DPCCH). These two CQI values are reported by the IC UE on HS-DPCCH to both the macro node and the LPN. By using both CQI values, the macro node has information on the channel condition between the interfering cell and the IC UE(s) which have reported CQI values. Based on these channel conditions, the interfering node selects the RRS condition for scheduling the RRS. Different RRS conditions may be used in different situations. The IC UE is configured in mode2 (NAIC_m mode or NAIC-RRS_m mode), so it feeds back the CQI values to both macro node 178 and LPN 172. The encoding of HS-DPCCH may be in SF-DC mode or MIMO mode. The interfering CQI may be fed back when a specified condition is met, reducing the feedback overhead. In one example, the reporting of the interfering CQI is determined based on the relationship between the estimated interfering CQI and a reporting threshold. When SF-DC coding is used, and the interfering CQI is below the reporting threshold, the IC UE reports a zero value (discontinuous transmission (DTX) value) for the interfering CQI using SF-DC, and when the estimated interfering CQI is above the reporting threshold, the IC UE reports the interfering CQI and serving cell CQI. In another example, where MIMO coding is used, when the estimated interfering CQI is below a reporting threshold, the IC UE only reports the serving cell CQI, and the interfering CQI is not reported. When the estimated interfering CQI is above the reporting threshold, the IC UE reports the interfering CQI and the serving cell CQI. In an additional example, the reporting of the interfering CQI is configured with a feedback cycle to reduce overhead.

LPN 172 extracts and decodes the two CQI values. Then, LPN 172 schedules the LPN IC UE on the RRS with the high priority based on the CQI values. The LPN schedules LPN edge IC UEs with high interfering CQI on RRS with high priority, so they are scheduled during RRSs with low interference.

Macro node 178 also extracts and decodes the two CQI values. Based on all the reported CQI_{Macro, LPN UE} values, the macro node determines the RRS condition. Then, during RRS, transport blocks are scheduled to fulfil the RRS condition.

In one example, for a post-decoding IC UE, the RRS condition is a threshold for the transport block size in the interfering cell. On RRS, only transport blocks with a size smaller than the threshold are scheduled in the interfering cell. In another example for a post-decoding IC UE, the condition is a transport block size threshold or a CQI threshold. The macro cell schedules macro UEs with CQI value within a certain interval [a, b], where a=f(CQI_i) and b=g(CQI_i) in the RRS.

In another example, for a pre-decoding IC UE, the RRS condition is the modulation type on the RRS. Alternatively, the RRS condition is a threshold of the code number. In one example, when modulation RRS condition is applied, when the maximum or average value of the reported interfering CQI values is less than a first threshold, quadrature phase key shifting (QPSK) modulation is used on the RRS, and when the maximum or average value of the reported interfering CQI values is above the first threshold and below a second threshold, QPSK and 16 quadrature amplification modulation (QAM) is used on the RRS. When the maximum or average value of the reported interfering CQI is above the second threshold, there is no condition on modulation. In another example where code restricted RRS is applied, when the maximum or average value of the reported interfering CQIs is below a first threshold, the code number of HS-PDSCHs is less than a first code number on the RRS, and when the maximum or average value of the reported interfering CQI is above the first threshold and below a second threshold, the code number of the HS-PDSCHs is less than a second code number on the RRS.

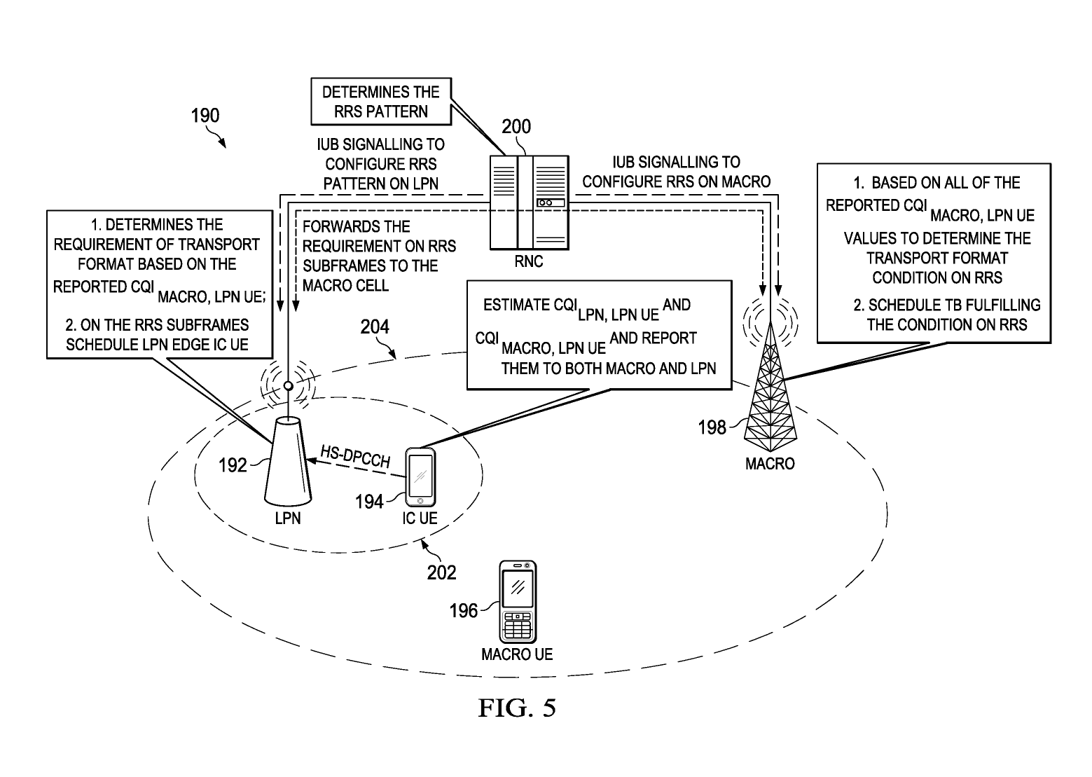

FIG. 5 illustrates system 190 for CQI feedback with RRS conditions. The RRS condition is used to cancel interference with IC efficiency. On the RRS, the interfering cell of the IC UE (macro node 198) schedules based on the RRS condition. Macro node 198 with coverage area 204 communicates with macro UE 196. Also in coverage area 204 is IC UE 194, which communicates with LPN 192 having a coverage area 202. Both LPN 192 and macro node 198 communicate with RNC 200. LPN 192 is the serving cell, while macro node 198 is the interfering cell for IC UE 194.

RNC 200 uses Iub signaling to configure the RRS pattern for the macro cell. RNC 200 transmits Iub signaling to LPN 192 and macro node 198 with the RRS pattern.

CQI values of the interfering cell are reported to the network as well as CQI values for the serving cell. IC UE 194 is configured in mode1 (NAIL mode or NAIC-RRS mode), so it reports the CQI values to LPN 192 and not to macro node 198. The IC UE evaluates the CQI of the serving cell and the CQI of the interfering cell, and uses HS-DPCCH with MIMO or SF-DC coding for transmission.

In reporting the interfering CQI, the interfering CQI may be fed back and/or the serving cell a specified condition, which reduces the feedback overhead. In reporting the two CQI values, the reporting of the interfering CQI may be determined based on the relationship between the estimated interfering CQI and a reporting threshold. When SF-DC coding is used and the estimated interfering CQI is below the reporting threshold, the IC UE reports a zero value (DTX) for the interfering CQI under SF-DC. On the other hand, when SF-DC coding is used and the estimated interfering CQI is greater than or equal to the reporting threshold, the IC UE reports the interfering cell CQI and the serving cell CQI to the network. When MIMO coding is used and the estimated interfering CQI is below the reporting threshold, the UE only reports the serving cell CQI, and the interfering CQI is not reported. When MIMO coding is used and the estimated interfering CQI is greater than or equal to the reporting threshold, the IC UE reports the interfering cell CQI and the serving cell CQI. Alternatively, the reporting of the interfering CQI is configured with a longer feedback.

LPN 192 detects the HS-DPCCH signal and decodes the two CQI values. The serving cell (LPN 192) forwards information, such as the CQI values or the RRS condition macro node 198 directly or indirectly through the RNC 200. LPN 192 schedules LPN edge IC UEs on RRS with high priority based on the CQI values and the RRS pattern. For example, the LPN edge IC UE with a high interfering CQI is scheduled on the RRS.

Macro node 198 does not detect the HS-DPCCH signal from the IC UE. Macro node 198 receives the forwarded interfering CQI values from LPN 192 directly or through RNC 200. When CQI values are received, macro node 198 determines the RRS condition. In one example with a post-decoding UE, the RRS condition is a threshold for the scheduled transport block size in the interfering cell. On RRS, only transport blocks with sizes smaller than the threshold are scheduled. In another example with a pre-decoding UC UE, the RRS condition is the modulation type on the RRS. The RRS condition may also be a threshold for the code number. On RRS, only frames with code numbers less than the threshold are scheduled. In one example with a post-decoding IC UE, the RRS condition is a CQI threshold. In one example, macro cells schedule macro UEs with CQI values below this threshold on the RRS. The macro node schedules certain macro UEs with TBSs with CQI values in an interval [a, b], where a=f(CQI_i) and b=g(CQI_i). In an example with a pre-decoding IC UE, the RRS condition is the modulation type or a threshold of the code number used on the RRS. When modulation RRS is applied, when the maximum or average value of the reported interfering CQI values is less than a first threshold, QPSK modulation is used on the RRS. When the maximum or average value of the CQI values is greater than or equal to the first threshold but less than a second threshold, the QPSK or 16-QAM modulation is used on the RRS. When the maximum or average of the reported CQI values is above the second threshold, there is no condition on modulation. When code restricted RRS condition is applied, when the maximum or average value of the reported interfering CQI values is less than a first threshold, the code number of HS-PDSCHs is less than a first code number on the RRS. On the other hand, when the maximum or average value of the reported interfering CQI values is greater than or equal to the first threshold but below a second threshold, the code number of HS-PDSCHs is less than a second code number on the RRS. When the average or maximum CQI is above the second threshold, there is no code number restriction

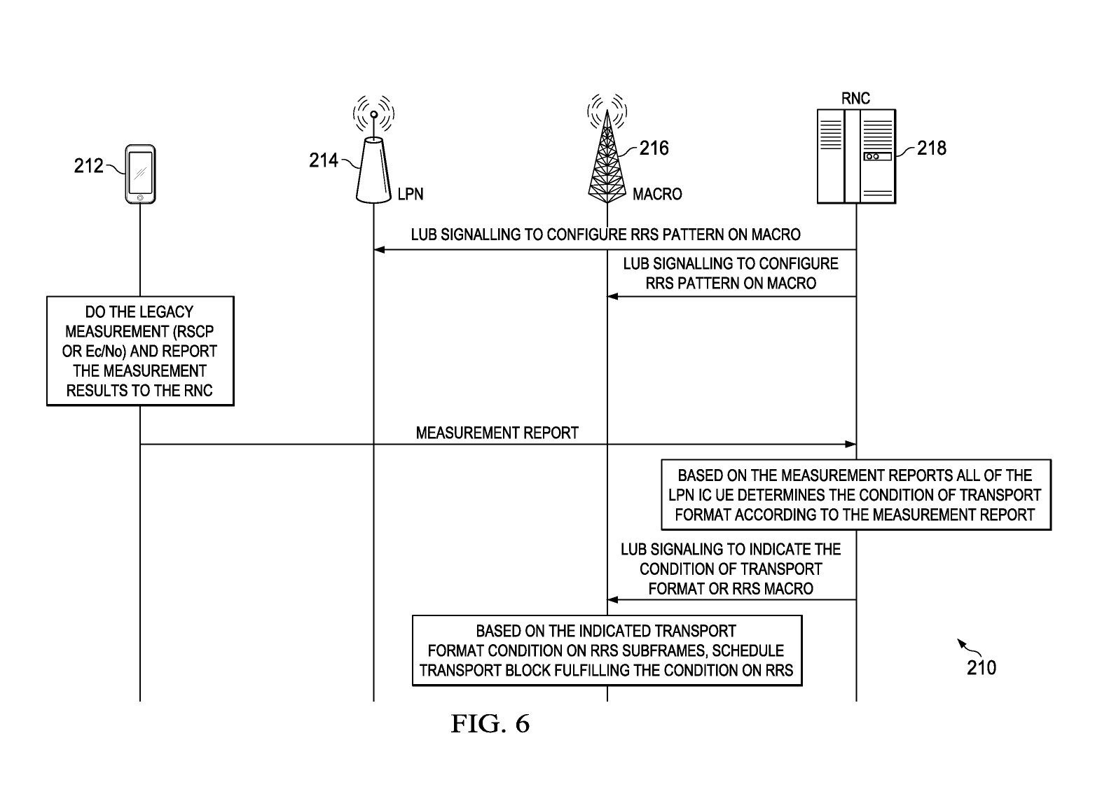

FIG. 6 illustrates message diagram 210 for CQI feedback using RRS conditions with an RNC. Initially, RNC 218 determines the RRS pattern configuration for the macro cell. RNC 218 uses Iub signaling to convey the RRS pattern to LPN 214 and macro node 216 for RRS coordination.

Then, IC UE 212 performs measurements related to the serving cell and interfering cell. The measurement may be the received signal code power (RSCP) or CPICH Ec/No measurements. These measurements are conveyed to RNC 218 in a measurement report. They may be transmitted to LPN 214 and forwarded to RNC 218 or directly sent to RNC 218.

RNC 218 determines the condition for the transport measurements based on the measurement report. In one example, the CPICH difference based on the CPICH Ec/No of the LPN and the CPICH Ec/No of the macro node is determined. A larger CPICH difference may indicate that the IC UE is near the macro node, and may have high interference. Also, the average CQI value for the macro cell and the LPN may be determine based on the CPICH Ec/No from the macro node and the CPICH Ec/No from the LPN. In another example, the measurement includes the location and IC gain of the IC UE, which may be used to enhance download scheduling.

RNC 218 transmits a message, such as an Iub message, to macro node 216 with the RRS condition for the macro cell. The macro cell than performs scheduling based on the RRS condition and the RRS pattern. Location information of the IC UE may also be received, which may enhance downloading scheduling. In one example with a post-decoding IC UE, the RRS condition is a threshold for the scheduled transport block size for the interfering cell and, on the RRS, only transport block sizes smaller than the threshold are scheduled. In another example with a pre-decoding IC UE, the RRS condition is a modulation type and/or a threshold on the number of codes, and on the RRS, only the specified modulation is scheduled in the macro cell, or only code numbers below the threshold are scheduled. The LPN may also schedule frames based on the RRS pattern.

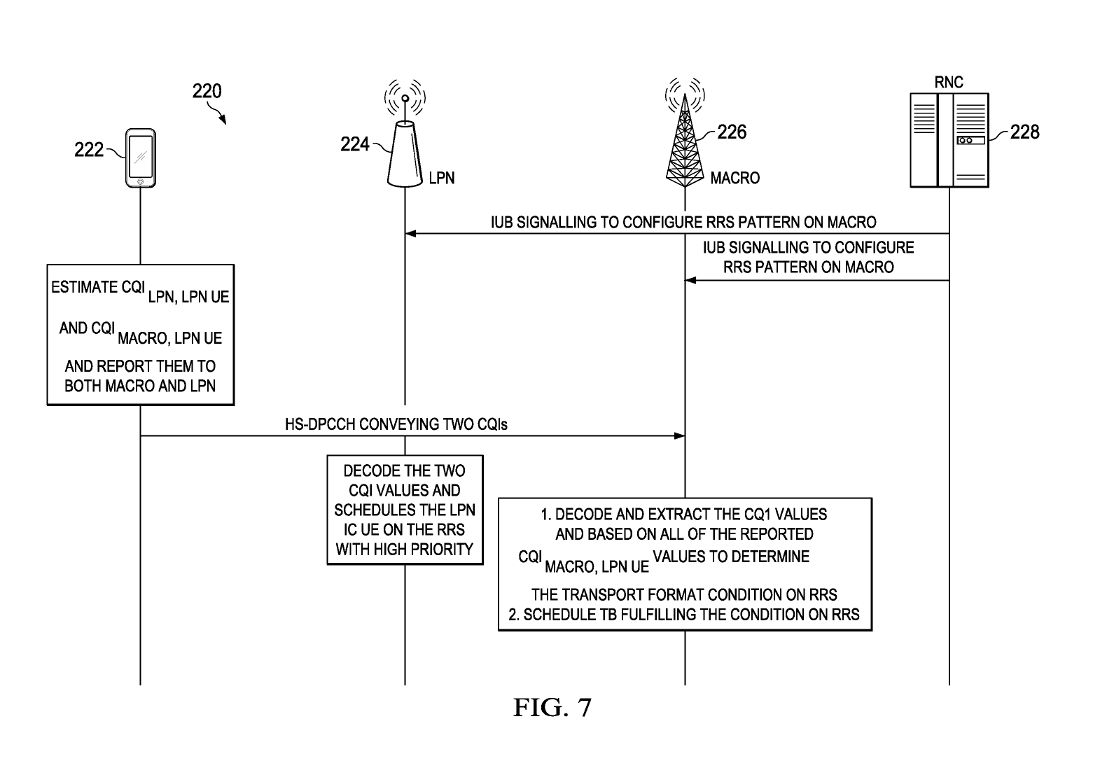

FIG. 7 illustrates message diagram 220 using dynamic RRS conditions performed by the interfering node. RNC 228 initial transmits parameters to configure RRS patterns on the macro cell to macro node 226 and LPN 224. Iub signaling may be used for this transmission.

IC UE 222 estimates the CQI values for the serving cell and interfering cells. These two CQI values are reported to LPN 224 and to macro node 226 using HS-DPCCH encoding. SF-DC encoding or MIMO encoding may be used. The interfering CQI and/or the serving cell CQI may only be reported when a reporting threshold is fulfilled.

LPN 224 detects and decodes the two CQI values and schedules the IC UE on the RRS having the highest priority based on these CQI values, such as IC UEs with high interference. The RRS pattern is used for the scheduling.

Macro node 226 also extracts and decodes the two CQI values and determines the RRS condition based on the CQI values. Transport blocks on the RRS are scheduled based on the channel conditions. The In one example, the RRS condition is a threshold size for scheduled transport blocks, where only transport blocks with a size below a threshold are scheduled in the macro cell on an RRS. In another example, the RRS condition is a CQI threshold, where macro UEs with CQI values within a particular interval are scheduled. In an additional example, the RRS condition is a modulation type, where modulation type is restricted for CQI values below a threshold or between thresholds. The RRS pattern from RNC 228 is used in scheduling

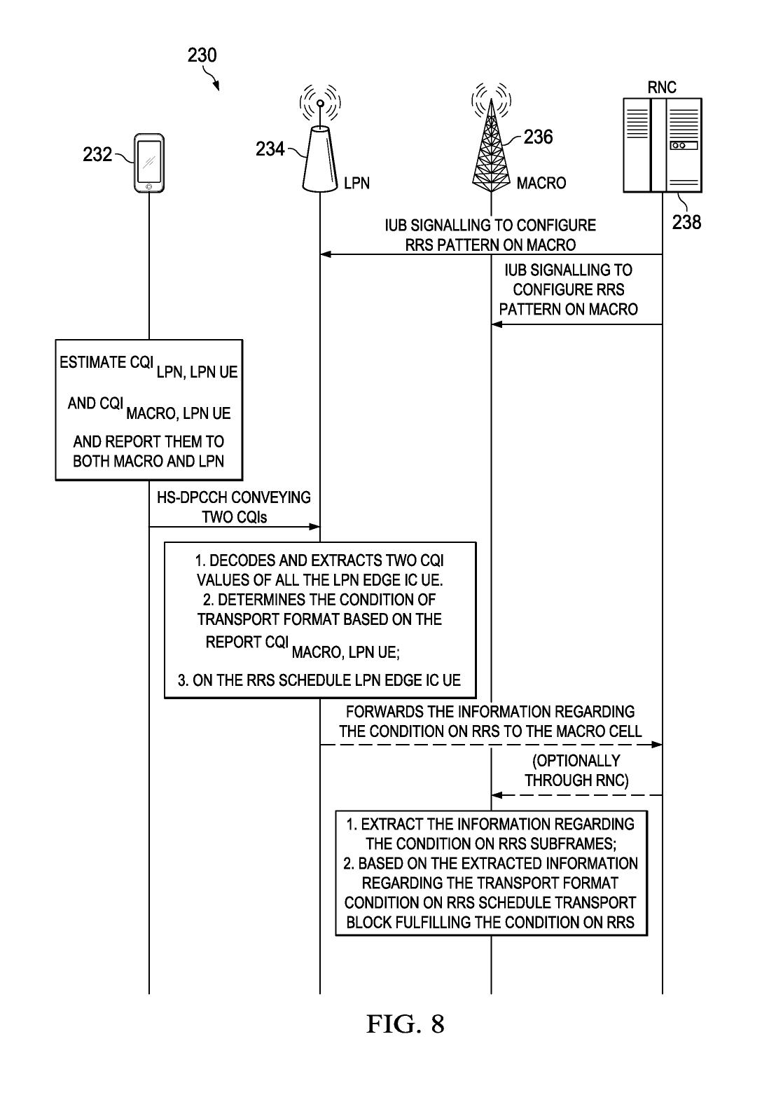

FIG. 8 illustrates message diagram 230 for using CQI feedback to determine RRS conditions. RNC 238 configures the RRS pattern for the macro cell, for example by transmitting Tub signaling to LPN 234 and macro node 236.

IC UE 232 estimates the CQI values both for the serving cell and for interfering cell(s). The CQI values are transmitted to LPN 234 using HS-DPCCH with MIMO or SF-DC coding. The CQI values may only be transmitted some of the time. For example, one or both CQI values may not be transmitted when the estimated interfering CQI is below a threshold. In another example, a long feedback is used.

LPN 234 detects and extracts the two CQI values for all of the IC UEs from the HS-DPCCHs. In one example, LPN 234 forwards the CQI values to macro node 236, for example via RNC 238, and macro node 236 determines the RRS condition. In another example, LPN 234 determines the RRS condition and transmits the RRS condition to macro node 236, for example through RNC 238. When the LPN determines the RRS condition, it may calculate a threshold based on the CQI values. The threshold may be a transport block size, code number, CQI, modulation scheme, or another factor. Also, the LPN schedules edge IC UEs on the RRS with a high priority based on the CQI values, where the RRS pattern is used in scheduling.

Macro node 236 does not detect the HS-DPCCH signal from the IC UE, but receives CQI information and/or a condition from LPN 234, for example through RNC 238 or directly. When the CQI values are received, macro node 236 determines the RRS condition, which may be a threshold for scheduled transport block size for RRSs, a required modulation type on the RRS, a threshold for the code number on RRSs, or a CQI threshold.

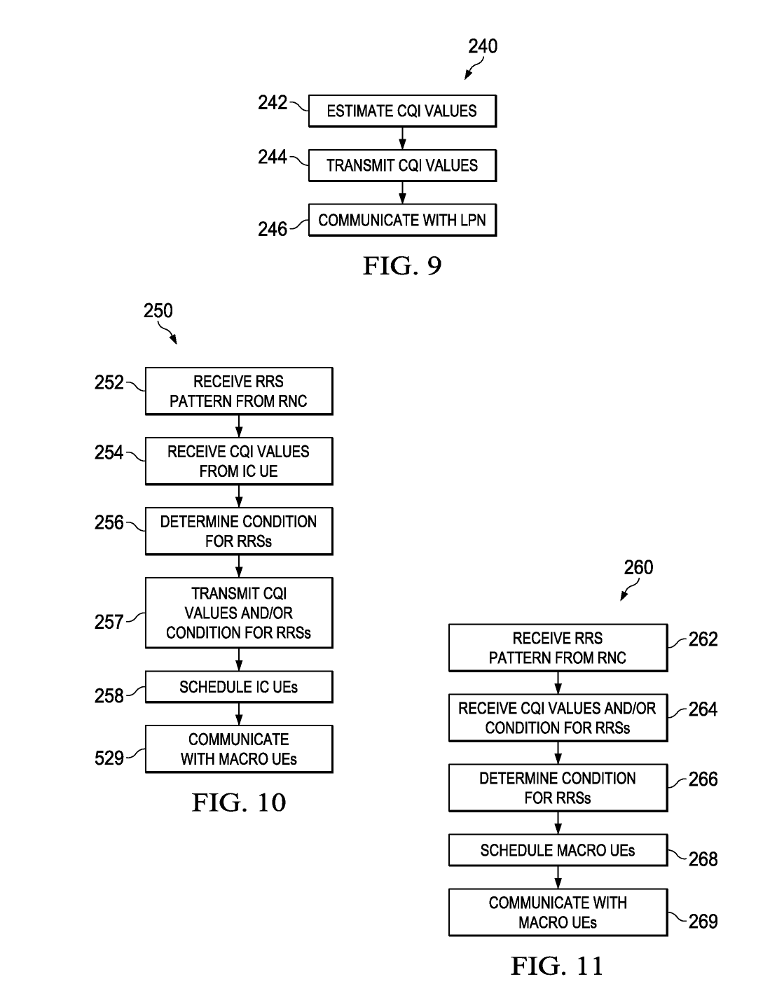

FIG. 9 illustrates flowchart 240 for an embodiment method of channel condition feedback performed by an IC UE. Initially, in step 242, the IC UE estimates indicators of channel condition for the serving cell and non-serving cell(s). Also, measurements of the RSPC and/or CPICH Ec/No of the serving node and the non-serving node may be performed.

Next, in step 244, the information from step 242 are transmitted. In one example, the RSPC measurement and/or CPICH Ec/No are transmitted to the RNC directly or through the serving node. In other examples, the indicators of channel condition are transmitted to the serving node, or to both the serving node and the non-serving node using HS-DPCCH encoding with SF-DC or MIMO coding. The indicators of channel condition may only be transmitted some of the time, for example when the interfering CQI value is above a threshold. When the interfering CQI value is below the threshold, one or both of the CQI values may not be reported. In another example, the CQI values are reported using a configured feedback cycle.

Finally, in step 246, the IC UE communicates with the serving node. The serving node coordinates the RRS schedule for this communication.

FIG. 10 illustrates flowchart 250 for an embodiment method of channel condition feedback performed by a serving node, such as an LPN. Initially, in step 252, the serving node receives Iub signaling from the RNC to configure the transmission pattern, for example the t pattern, for the macro cell.

Next, in step 254, the serving node receives indicators of channel conditions, such as CQI values, from the IC UE. The indicators of channel condition may be HS-DPCCH encoded, either using SF-DC coding or MIMO coding. The serving node decodes and extracts the two indicators of channel conditions.

Then, in step 256, the serving node may determine the transmission condition based on the two indicators of channel condition. The transmission condition may be an RRS condition or another transmission condition. In some embodiments, step 256 is not performed. In one example, the condition is a transport block threshold. In other example, the condition is a threshold for a code number, a modulation scheme, or a CQI threshold.

In step 257, the serving node transmits a message. The serving node may forward the indicators of channel condition received in step 254 or using the transmission condition from step 256. In some examples, step 257 is not performed. In one example, the indicators of channel condition are forwarded to the non-serving node. In another example, the transmission condition is transmitted to the macro cell, or to the RNC destined for the macro cell.

The serving node schedules IC UEs in step 258 using the transmission pattern received in step 252. The IC UEs with high priority are scheduled in the transmission pattern. For examples, IC UEs on the edge of the serving node coverage area with high interfering CQI values have a high priority to be scheduled during the transmission pattern.

Finally, in step 259, the serving node communicates with IC UE(s) based on the schedule from step 258. The serving node transmits signals to and receives signals from IC UE(s) scheduled during the RRS.

FIG. 11 illustrates flowchart 260 for a method of channel condition feedback with transmission conditions performed by a non-serving node, such as a macro node. Initially, in step 262, the non-serving node receives transmission pattern configuration information from the RNC, for example using Iub signaling.

Next, in step 264, the non-serving node receives indicators of channel conditions or transmission conditions from an IC UE directly or through a serving node or RNC. In one example, the non-serving node receives the two indicators of channel conditions from each IC UE. The indicators of channel conditions may be received using HS-DPCCH encoding, for example using SF-DC or MIMO coding. The indicators of channel conditions may be relayed through a serving cell or an RNC. The non-serving node extracts and decodes the indicators of channel conditions. In another example, the non-serving node receives the transmission condition, for example from the RNC or from the serving node.

In step 266, the non-serving node determines the transmission condition based on the indicators of channel conditions. In other embodiments, step 266 is not performed. The transmission condition may be a transport block condition, a code number condition, a CQI condition, a modulation condition, or another condition during the transmission pattern.

In step 268, the non-serving node schedules UEs based on the transmission condition in step 264 or determined in step 266 based on the transmission pattern received in step 262. UEs during the transmission pattern are selected to avoid interference with IC UEs.

Finally, in step 269, the non-serving node communicates with UEs using the schedule determined in step 268. The non-serving node transmits and receives messages.

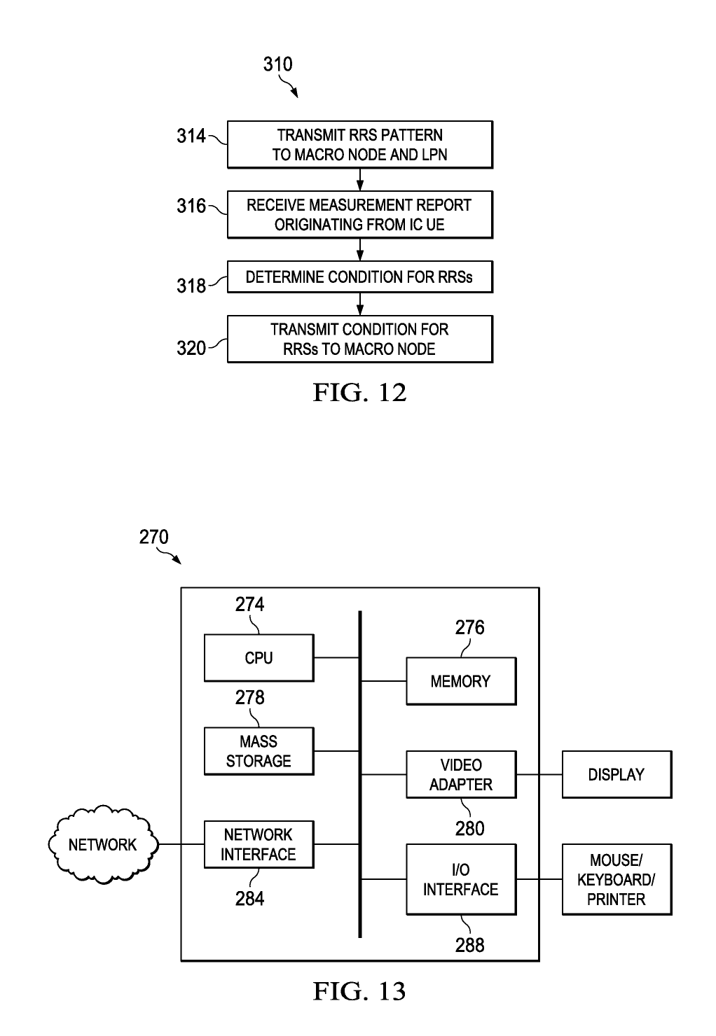

FIG. 12 illustrates flowchart 310 for an embodiment method of channel condition feedback with transmission conditions performed by an RNC. Initially, in step 314, the RNC transmits info the RRS pattern configuration information in a non-serving cell. The transmission pattern configuration may be transmitted to the non-serving node and the serving node using Tub signaling.

Then, in step 316, the RNC receives a measurement report originating from an IC UE. The measurement report may be conveyed by a serving cell, such as an LPN. The measurement report contains information on the serving cell channel and the non-serving channel, such as the RSCP or CPICH Ec/No of the serving cell and the non-serving cell(s). In one example the location and/or gain potential of the IC UE is received, which may be used in determining the transmission condition.

Next, in step 318, the RNC determines the transmission condition based on the measurement report. The CPICH difference of IC UEs based on the CPICH Ec/No of the serving node and the non-serving node may be determined. A larger CPICH difference indicates that the IC UE is farther away from the serving node and closer to a non-serving node, and is prone to interference. When the IC UE is closer to the non-serving node, more IC gain may be needed. The transmission condition may be a transport format on the transmission pattern for the non-serving node. Also, the average cell channel condition and serving cell channel condition may be determined based on the CPICH Ec/No. In one example, the location information or IC gain are used in the scheduling.

Finally, in step 320, the RNC transmits the transmission conditions determined in step 318 to the UE, for example using Iub signaling.

FIG. 13 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adaptor 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of non-transitory system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of non-transitory storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like.

Video adaptor 280 and I/O interface 288 provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not pictured) may be used to provide a serial interface for a printer.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method comprising:
receiving a first indicator of channel quality between a user equipment (UE) and a first network node;
receiving a second indicator of channel quality between the UE and a second network node;
processing the first indicator of channel quality; and
processing the second indicator of channel quality.

2. The method of claim 1, further comprising determining a transmission condition in accordance with the first and second indicator of channel quality.

3. The method of claim 2, wherein the transmission condition is a restricted resource subframe condition.

4. The method of claim 2, further comprising receiving, by the first network node from a radio network controller (RNC), the transmission condition.

5. The method of claim 2, further comprising transmitting, by the first network node to an RNC, the transmission condition, wherein the transmission condition is destined for the second network node.

6. The method of claim 2, wherein the transmission condition is selected from the group consisting of a transport block size condition, a channel quality condition, a code number condition, and a modulation condition.

7. The method of claim 1, wherein the first network node is a serving node and the second network node is a non-serving node.

8. The method of claim 7, wherein the non-serving node is included in an active set of the UE.

9. The method of claim 7, wherein the non-serving node is not included in an active set of the UE.

10. The method of claim 1, further comprising scheduling a transport block in accordance with the first indicator of channel quality and the second indicator of channel quality.

11. The method of claim 10, further comprising transmitting, by the first network node to the UE, the scheduled transport block.

12. The method of claim 1, wherein the processing further comprises sending the first and second indicator of channel quality to a third network node.

13. A method comprising:
transmitting, by a radio network controller (RNC) to a serving node, a transmission pattern;
transmitting, by the RNC to a non-serving node, the transmission pattern;
receiving, by the RNC, a measurement report indicating a quality of a first channel between a user equipment (UE) and the serving node and a quality of a second channel between the UE and the non-serving node; and
determining a transmission condition in accordance with the measurement report.

14. The method of claim 13, further comprising transmitting, by the RNC to the non-serving node, the transmission condition.

15. The method of claim 13, wherein the measurement report comprises a first common pilot channel (CPICH) energy per chip (Ec) on spectral density (No) of the first channel and a second CPICH Ec/No of the second channel.

16. The method of claim 13, wherein transmitting, by the RNC to the serving node, the transmission pattern comprises transmitting the transmission pattern on Iub signaling.

17. A method comprising:
determining a first indicator of channel quality between a user equipment (UE) and a serving node;
determining a second indicator of channel quality between the UE and a first non-serving node;
transmitting the first indicator of channel quality; and
transmitting the second indicator of channel quality.

18. The method of claim 17, wherein transmitting the first indicator of channel quality comprises encoding the first indicator of channel quality with high speed dedicated physical control channel (HS-DPCCH), and wherein transmitting the second indicator of channel quality comprises encoding the second indicator of channel quality with HS-DPCCH.

19. The method of claim 18, wherein encoding the first indicator of channel quality comprises encoding the first indicator of channel quality in universal mobile telecommunications service (UMTS) single frequency dual cell (SF-DC) mode or multiple-input multiple-output (MIMO) mode.

20. The method of claim 17, further comprising:
transmitting, by the UE to a radio network controller (RNC), the first indicator of channel quality; and
transmitting, by the UE to the RNC, the second indicator of channel quality.

21. The method of claim 17, further comprising:
determining a third indicator of channel quality between the UE and a second non-serving node; and
transmitting the third indicator of channel quality.

22. A method comprising:
receiving, by a radio network controller (RNC) from a user equipment (UE), a first indicator of channel quality;
receiving, by the RNC from the UE, a second indicator of channel quality;
processing the first indicator of channel quality; and
processing the second indicator of channel quality.

23. The method of claim 22, further comprising:
determining a transmission condition in accordance with the first indicator of channel quality and the second indicator of channel quality; and
transmitting, by the RNC to a first network node, the transmission condition.

24. The method of claim 23, further comprising transmitting, by the RNC to a plurality of network nodes, the transmission condition.

25. A first network node comprising:
a processor; and
a non-transitory computer readable storage medium storing programming for execution by the processor, the programming including instructions to
receive a first indicator of channel quality between a first user equipment (UE), and the first network node,
receive a second indicator of channel quality between the UE and a second network node,
process the first indicator of channel quality, and
process the second indicator of channel quality.
